(19) United States
(12) Patent Application Publication
(10) Pub. No.: US 2004/0027829 A1
(43) Pub. Date: Feb. 12, 2004

(54) Variable thickness light diffuser

(76) Inventors: Jacklyn M. Dowdy, Fort Collins, CO (US); Jesse M. Gerrard, Loveland, CO (US)

Correspondence Address: HEWLETT-PACKARD COMPANY, Intellectual Property Administration, P. O. Box 272400, Fort Collins, CO, 80527-2400, US

(21) Appl. No.: 10/637,422

(22) Filed: Aug. 8, 2003

Related U.S. Application Data
(63) Continuation of application No. 10/159,855, filed on May 31, 2002.

(51) Int. Cl. F21V 3/00

(52) U.S. Cl. 362/326; 362/311

(57) ABSTRACT

In representative embodiments, an apparatus includes a semi-transparent material piece having a particulate distributed within the piece, wherein the particulate is capable of diffusing light passing through the piece. In a preselected direction, the thickness of the piece varies with position. When light enters the piece in the preselected direction, the piece diffuses the light more in regions of greater thickness than in regions of lesser thickness. In other representative embodiments, another apparatus includes a light source, a reflector, and a semi-transparent material piece. The reflector is capable of redirecting light from the light source onto a surface of the piece. A particulate is distributed within the piece, wherein the particulate is capable of diffusing light passing through the piece. In a preselected direction, the thickness of the piece varies with position. When light enters the piece in the preselected direction, the piece diffuses the light more in regions of greater thickness than in regions of lesser thickness.

### BACKGROUND

Scanners are used with modern computers to create electronic images of a variety of items such as documents, photographs, transparencies, photographic slides, and negatives of photographs by detecting the light reflected by or transmitted through such items. The detected optical signal is converted to an electrical signal which can be stored by the computer for future use. In creating the electronic image, the items are typically illuminated and scanned by moving an optical sensor across the item. The optical sensor is also referred to as an image sensor, and the process is referred to as scanning. Scanners can be used to scan documents and photographs using reflected light. They can also be used to scan transparent media such as transparencies, photographic slides, and negatives of photographs using transmitted light. In the case of photographic slides and photographic negatives, adapters are commonly used to transmit light through the scanned media to a detection device.

Uniform illumination of the item is important in the creation of an accurate image. Some applications use reflectors to direct the light from a light source toward the object. Appropriate design of the reflector which could be, for example, a reflective parabolic or other curved surface also results in a more uniformly distributed illumination of the item. Often, however, the result is less uniformity than needed.

An additional improvement in illumination uniformity can be obtained by placing a sheet of a semi-transparent material having a given thickness between the light source or light source/reflector combination and the object to be scanned. The sheet of semi-transparent material diffuses the light, thus reducing hot spots and making the light more generally uniform in its illumination of the object. Light diffusion is obtained by distributing particulate matter more or less uniformly throughout the sheet. The more particulate included in the sheet and the thicker the sheet, the more the diffusion and the associated illumination uniformity. However, the greater the particulate content and the thicker the sheet, the less light is available for illuminating the object. In practical designs, i.e., one in which sufficient light intensity illuminates the object, the resultant uniformity of illumination is still often less than desired.

### SUMMARY

In representative embodiments, an apparatus is disclosed for diffusing light that comprises a semi-transparent material piece having a particulate distributed within the piece, wherein the particulate is capable of diffusing light passing through the piece. In a preselected direction, the thickness of the piece varies with position. When light enters the piece in the preselected direction, the piece diffuses the light more in regions of greater thickness than in regions of lesser thickness.

In other representative embodiments, another apparatus is disclosed that comprises a light source, a reflector, and a semi-transparent material piece. The reflector is capable of redirecting light from the light source onto a surface of the piece. A particulate is distributed within the piece, wherein the particulate is capable of diffusing light passing through the piece. In a preselected direction, the thickness of the piece varies with position. When light enters the piece in the preselected direction, the piece diffuses the light more in regions of greater thickness than in regions of lesser thickness.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements.

FIG. 1A is a drawing of an embodiment of an apparatus for diffusing light consistent with the teachings of the invention.

FIG. 1B is a drawing of a front view of the apparatus of FIG. 1A.

FIG. 2 is a drawing of an embodiment of an optical scanner with the apparatus of FIG. 1A.

FIG. 3 is a cross-sectional drawing of an embodiment of a semi-transparent piece of material consistent with the teachings of the invention.

FIG. 4 is another cross-sectional drawing of an embodiment of a semi-transparent piece of material consistent with the teachings of the invention.

FIG. 5 is a drawing of an embodiment of a small volume of a semi-transparent piece of material consistent with the teachings of the invention.

### DETAILED DESCRIPTION

As shown in the drawings for purposes of illustration, the present patent document relates to a novel technique for diffusing light from a light source. In existing illumination systems, a degree of illumination uniformity is obtained by placing a sheet of a semi-transparent material having a given thickness and a given density of particulate to diffuse the light between the light source and the area to be illuminated. As disclosed in representative embodiments, by locally modifying the thickness of the sheet, a more uniform distribution of the illumination can be obtained.

In the following detailed description and in the several figures of the drawings, like elements are identified with like reference numerals.

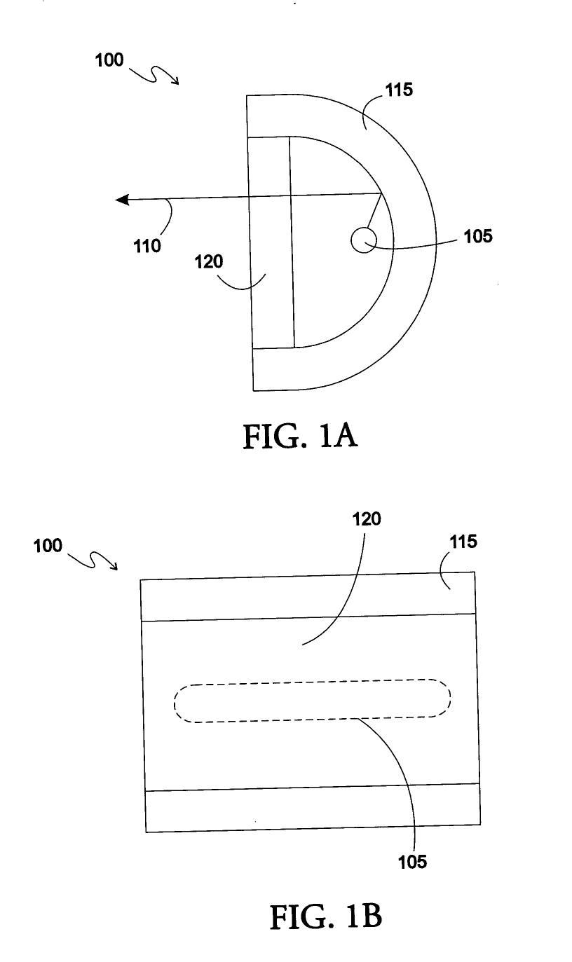

FIG. 1A is a drawing of an embodiment of an apparatus 100 for diffusing light 110 consistent with the teachings of the invention. FIG. 1A is a side-view of the apparatus 100. In FIG. 1A, when a light source 105 is activated, light 110 from the light source 105 is redirected by a reflector 115 and passes through a semi-transparent piece 120 of material.

FIG. 1B is a drawing of a front view of the apparatus 100 of FIG. 1A. In FIG. 1B, the light source 105 is hidden behind the reflector 115.

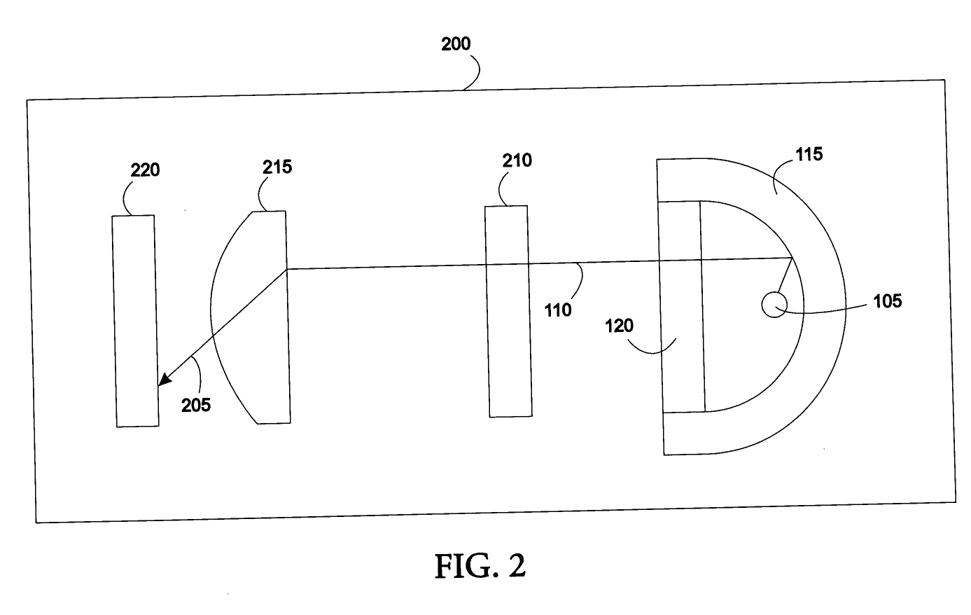

FIG. 2 is a drawing of an embodiment of an optical scanner 200 with the apparatus of FIG. 1A. FIG. 2 shows the basic function of the scanner 200 in detecting an optical signal 205 from an object 210 which, in this example, is a transparent medium 210. In FIG. 2, light 110 from the light source 105 is redirected by the reflector 115 and subsequently diffused by the semi-transparent piece 120. The diffused light 110 then passes through the transparent medium 210, is focused by a lens 215, and is detected by an image sensor 220.

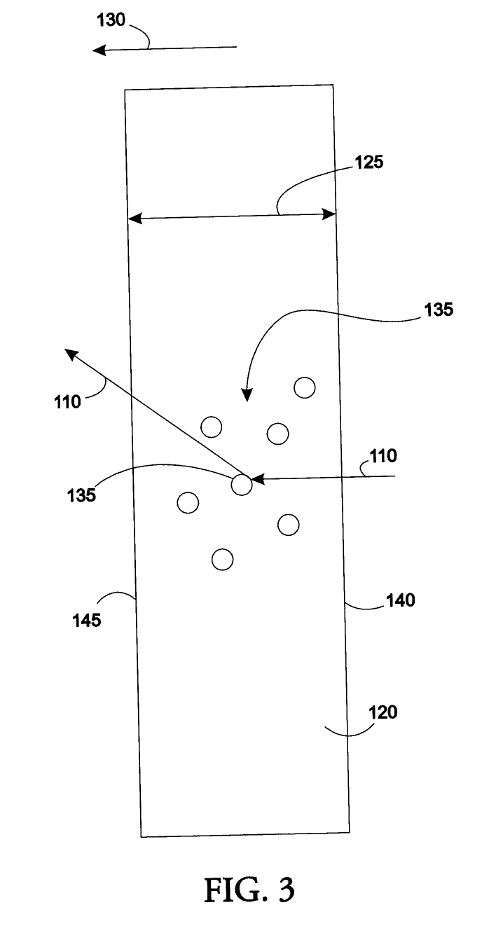

FIG. 3 is a cross-sectional drawing of an embodiment of a semi-transparent piece 120 of material consistent with the teachings of the invention. The semi-transparent piece 120 of material has a thickness 125 in a direction 130 of intended light transmission following reflection from the reflector 115. Also shown in FIG. 3 are a representative sample of a particulate 135 distributed in the semi-transparent piece 120. Light entering the semi-transparent piece 120 through an entry surface 140 is scattered by the particulate 135 prior to exiting the semi-transparent piece 120 through an exit surface 145. For illustrative purposes, a single ray of light 110 is shown entering through the entry surface 140, being scattered by the particulate 135, and exiting the semi-transparent piece 120 through the exit surface 145.

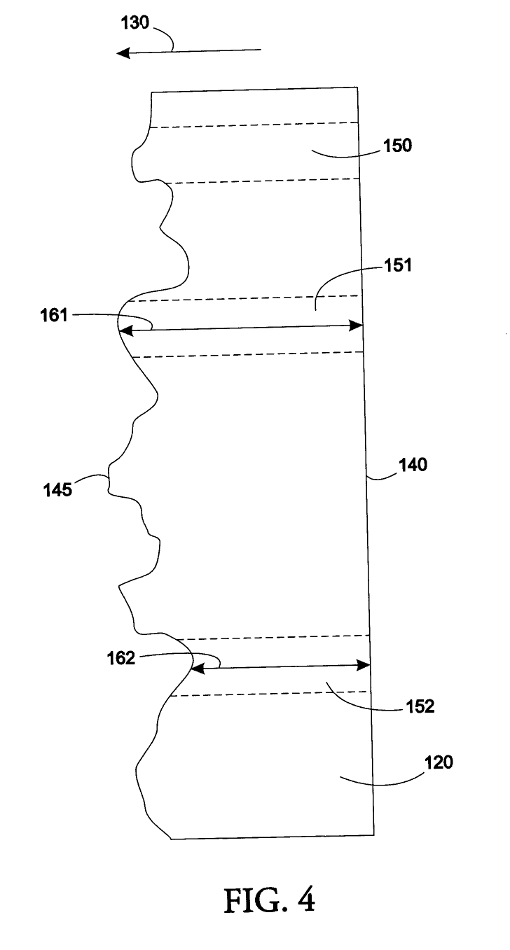

FIG. 4 is another cross-sectional drawing of an embodiment of a semi-transparent piece 120 of material consistent with the teachings of the invention. As shown in FIG. 4, the semi-transparent piece 120 has thickness 125 as shown in FIG. 3 which varies with position. Assuming that the particulate 135 is uniformly distributed throughout the semi-transparent piece 120, the light is diffused uniformly throughout the piece 120. The thicker the material, the more scattering the light 110 will experience as it passes through the semi-transparent piece 120 of material. Also as shown in FIG. 4, the semi-transparent piece 120 is conceptually divided into multiple small volumes 150. For clarity of illustration, only two small volumes 150 identified as a first small volume 151 and a second small volume 152, occurring in different regions of the semi-transparent piece 120, are shown. Each small volume 150 is bounded by a portion of the entry surface 140 and by a portion of the exit surface 145, and has thickness 125 in the direction 130 of intended light transmission. The first small volume 151 has thickness 161, and the second small volume 152 has thickness 162 which is smaller than thickness 161 of the first small volume 151. Thus, when light 110 passes through the first and second small volumes 151,152, that portion of the light 110 that passes through the first small volume 151 is diffused to a greater extent than that portion of the light 110 that passes through the second small volume 152.

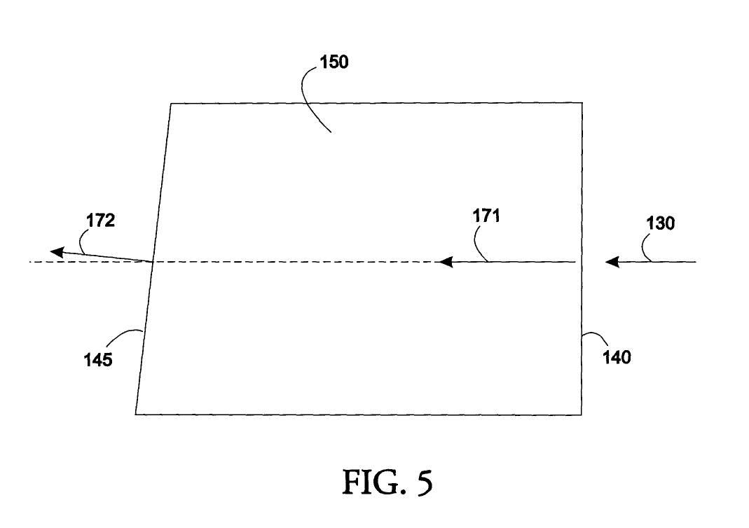

FIG. 5 is a drawing of an embodiment of a small volume of a semi-transparent piece 120 of material consistent with the teachings of the invention. As shown in FIG. 5, an entry surface normal 171, wherein the entry surface normal 171 is the surface normal of the entry surface 140, and an exit surface normal 172, wherein the exit surface normal 172 is the surface normal of the exit surface 145, will typically lie in the general direction 130 of the intended light 110 transmission.

The intensity of illumination received by particular areas of the object being scanned can be reduced by increasing the thickness 125 of the appropriate sections of the semi-transparent piece 120 of material through which the light 110 passes. Conversely, the intensity of illumination received by particular areas of the object being scanned can be increased by decreasing the thickness 125 of the appropriate sections of the semi-transparent piece 120 of material through which the light 110 passes. It will be understood by one of ordinary skill in the art that light 110 exiting the semi-transparent piece 120 from a particular small volume 150 may have entered the semi-transparent piece 120 through a different small volume 150.

Preferably the geometry of the semi-transparent piece 120 is designed and manufactured so as to diffuse the pattern of light 110 which it ultimately receives from the light source 105 in such a manner that an illumination of the object 210 is obtained that is optimized for uniformity. Thus, the design of the semi-transparent piece 120 preferably considers the apparatus 100 within which it will function.

A primary advantage of the embodiment as described herein over prior techniques is that the light 110 is more uniformly distributed over the surface of the object being scanned resulting in the creation of a more accurate electronic image. The semi-transparent piece 120 of material can be inexpensively fabricated by molding or other means.

It is noted that while in the representative embodiments shown, different thicknesses 125, indicated as thickness 161 and thickness 162, were shown in FIG. 4 with the entry surface 140 flat and the exit surface 145 varying with position on the semi-transparent piece 120, this is not a requirement. In another embodiment, the exit surface 145 is maintained flat and the entry surface 140 is allowed to vary with position on the semi-transparent piece 120. While in still another embodiment, both the entry surface 140 and the exit surface 145 deviate from the flat as the position on the semi-transparent piece 120 varies. It is noted that while the representative embodiments disclosed herein are related to electronic scanners, the invention is not limited to such devices but can be more generally used with in other applications. In particular, the teachings disclosed herein apply broadly to those applications in which the diffusion of light is advantageous.

What is claimed is:

1. An apparatus for diffusing light, comprising:
a semi-transparent material piece, wherein a particulate is distributed uniformly within the piece, wherein, in a preselected direction, the thickness of the piece varies non-randomly and non-periodically with position in a direction perpendicular to the preselected direction, wherein the particulate is capable of diffusing light passing through the piece, wherein, when light enters the piece in the preselected direction, the piece diffuses the light more in regions of greater thickness than in regions of lesser thickness.

2. The apparatus as recited in claim 1, wherein the piece is conceptually divided into multiple contiguous small volumes, wherein each small volume has a thickness in the preselected direction, wherein each small volume has an entry surface through which incident light is capable of entering and an exit surface through which that light is capable of exiting, wherein surface normals of the entry and exit surfaces are substantially parallel to the preselected direction, wherein a first and second small volumes are selected from the set of multiple small volumes, wherein the thickness of the first small volume is greater than the thickness of the second small volume, and wherein when light passes through the first and second small volumes, that portion of the light passing through the first small volume is diffused more than that portion of the light passing through the second small volume.

3. The apparatus as recited in claim 2, further comprising a reflector, wherein the reflector is capable of redirecting light from a light source onto a surface of the piece.

4. The apparatus as recited in claim 2, further comprising a light source, wherein the light source is capable of illuminating a surface of the piece.

5. The apparatus as recited in claim 4, further comprising an image sensor upon which the light is incident following illumination of the surface of the piece.

6. The apparatus as recited in claim 1, wherein the piece is fabricated via a molding process.

7. The apparatus as recited in claim 1, further comprising a reflector, wherein the reflector is capable of redirecting light from a light source onto a surface of the piece.

8. The apparatus as recited in claim 1, further comprising a light source, wherein the light source is capable of illuminating a surface of the piece.

9. The apparatus as recited in claim 8, further comprising an image sensor upon which the light is incident following illumination of the surface of the piece.

10. An apparatus for diffusing light, comprising:
a light source;
a reflector; and
a semi-transparent material piece, wherein the reflector is capable of redirecting light from the light source onto a surface of the piece, wherein a particulate is distributed within the piece, wherein, in a preselected direction, the thickness of the piece varies non-randomly and non-periodically with position in a direction perpendicular to the preselected direction, wherein the particulate is capable of diffusing light passing through the piece, wherein, when light enters the piece in the preselected direction, the piece diffuses of the light more in regions of greater thickness than in regions of lesser thickness.

11. The apparatus as recited in claim 10, wherein the piece is conceptually divided into multiple contiguous small volumes, wherein each small volume has a thickness in the preselected direction, wherein each small volume has an entry surface through which incident light is capable of entering and an exit surface through which that light is capable of exiting, wherein surface normals of the entry and exit surfaces are substantially parallel to the preselected direction, wherein a first and second small volumes are selected from the set of multiple small volumes, wherein the thickness of the first small volume is greater than the thickness of the second small volume, and wherein when light passes through the first and second small volumes, that portion of the light passing through the first small volume is diffused more than that portion of the light passing through the second small volume.

12. The apparatus as recited in claim 11, further comprising an image sensor upon which the light is incident following illumination of the surface of the piece.

13. The apparatus as recited in claim 10, wherein the piece is fabricated via a molding process.

14. The apparatus as recited in claim 10, further comprising an image sensor upon which the light is incident following illumination of the surface of the piece.
